(19) United States
(12) Patent Application Publication
(10) Pub. No.: US 2025/0139236 A1
(43) Pub. Date: May 1, 2025

(54) Monitoring A Computing System With Respect To A Recovery Scenario

(71) Applicant: Telefonaktiebolaget LM Ericsson (PUBL), Stockholm (SE)

(72) Inventors: Anu Puhakainen, ESPOO (FI); Harri Hakala, TURKU (FI); Joel Patrik Reijonen, KIRKKONUMMI (FI)

(21) Appl. No.: 18/694,218

(22) PCT Filed: Sep. 22, 2021
(86) PCT No.: PCT/EP2021/076127

§ 371 Date: Mar. 21, 2024

(51) Int. Cl. G06F 21/55

(52) U.S. Cl. CPC G06F 21/552; G06F 2221/034

(57) ABSTRACT

Computer implemented systems and methods for use in monitoring a computing system (716) with respect to occurrence of a recovery scenario from which the computing system would require recovery. A method (200) comprises determining (202) a risk that the computing system will undergo the recovery scenario, and responsive to the determined risk, performing (204) one or more pre-emptive actions so as mitigate against occurrence of the recovery scenario. The pre-emptive actions comprise: a) adding a security control to compensate for the recovery scenario; b) creating an image of part of the computing system; c) storing artifacts of the computing system in a storage space that is separate from the computing system; d) encrypting or deleting data from the computing system; and/or e) disabling one or more components in the computing system.

### TECHNICAL FIELD

This disclosure relates to security systems and security methods for monitoring a computing system. More particularly but non-exclusively, the disclosure relates to monitoring a computing system with respect to a recovery scenario from which the computing system would require recovery. The disclosure also relates to a computer program, a carrier and a computer program product.

### BACKGROUND

This disclosure relates to systems for monitoring a computing system such as an Information Technology (IT) systems and a telecommunication system with respect to recovery scenarios, from which the computing system would require system recovery (e.g. by restoring the system using back-ups and the like). Recovery scenarios may arise, e.g. through third party attacks, or other system failures due to factors such as hardware and/or software malfunctions or environmental factors (e.g. flooding or fire).

Current strategies for dealing with recovery scenarios include:
Developing appropriate activities i.e. processes to establish and maintain recovery plans and strategies for resilience and to restore any capabilities or services from backups. The focus is generally on processes, strategies, lessons learned, managing public relations and giving guidance for how to develop recovery plans. Such strategies are described in the documents: “NIST Cybersecurity Framework v1.1, recover controls”, section 2.1 and Appendix A; and NIST SP800-184 Guide for Cybersecurity Event Recovery.
Performing regular backups of the systems and storing them into remote destination(s) for later usage. Restoring backups is regarded as the main technical recovery action and executed according to business continuity and disaster recovery plans and processes.
Administrators restoring systems from clean backups, installing patches, rebuilding systems from scratch, changing passwords and tightening network perimeter security. Such strategies are described in the document: “NIST SP800-61 Computer Security Incident Handling Guide”; section 3.3.4.
Scale-in and scale-out technologies are used for virtualized environments, mainly from the performance and capacity perspective.

The main philosophy in the existing technology and processes used is to prevent recovery situations taking place by having in depth protection mechanisms in place to prevent or stop the attacks in the first place. This is performed by deploying firewalls, intrusion prevention systems and security incident and event management systems.

Another strategy involves performing regular penetration tests for the systems to reveal weak points and existing exploitable vulnerabilities in the systems and addressing those vulnerabilities. Known vulnerabilities may be remediated by installing security patches to the systems in order to prevent incidents exploiting known vulnerabilities from taking place.

There are various problems associated with current recovery practices that arise because system recovery is often considered and addressed primarily from an operational process and strategy perspective using recovery plans, recovery processes and activity descriptions which may be in paper format. Furthermore, current practices may focus on training perspectives associated with executing aftermath and “lessons learned” exercises, raising awareness, public relations/brand reputation perspectives and/or communication recovery activities towards company management.

### SUMMARY

An object of the invention is to improve security and enable more efficient maintenance of a computer system. The invention enables the impact of the recovery scenario to be reduced and recovery outcomes to be improved. Embodiments herein describe determining risks of different recovery scenarios and actions that may be performed, so as to better manage recovery scenarios. In this way, the course of events may be turned such that full recovery processes are not required e.g. by limiting or minimising consequences of an emerging recovery scenario.

According to a first aspect herein there is a method for use in monitoring a computing system with respect to occurrence of a recovery scenario from which the computing system would require recovery. The method comprises: determining a risk that the computing system will undergo the recovery scenario; and responsive to the determined risk, performing one or more pre-emptive actions so as mitigate against occurrence of the recovery scenario. The pre-emptive actions comprise: a) adding a security control to compensate for the recovery scenario; b) creating an image of part of the computing system; c) storing artifacts of the computing system in a storage space that is separate from the computing system; d) encrypting or deleting data from the computing system; and/or e) disabling one or more components in the computing system.

According to a second aspect herein there is a security system for use in monitoring a computing system with respect to occurrence of a recovery scenario from which the computing system would require recovery, wherein the security system is configured to: determine a risk that the computing system will undergo the recovery scenario; and perform one or more pre-emptive actions so as mitigate against occurrence of the recovery scenario, wherein the pre-emptive actions comprise: a) adding a security control to compensate for the recovery scenario; b) creating an image of part of the computing system; c) storing artifacts of the computing system in a storage space that is separate from the computing system; d) encrypting or deleting data from the computing system; and/or e) disabling one or more components in the computing system.

According to a third aspect herein there is a security system for use in monitoring a computing system with respect to occurrence of a recovery scenario from which the computing system would require recovery, the security system comprising: a memory comprising instruction data representing a set of instructions; and a processor configured to communicate with the memory and to execute the set of instructions. The set of instructions, when executed by the processor, cause the security system to: determine a risk that the computing system will undergo the recovery scenario; and perform one or more pre-emptive actions so as mitigate against occurrence of the recovery scenario, wherein the pre-emptive actions comprise: a) adding a security control to compensate for the recovery scenario; b) creating an image of part of the computing system; c) storing artifacts of the computing system in a storage space that is separate from the computing system; d) encrypting or deleting data from the computing system; and/or e) disabling one or more components in the computing system.

According to a fourth aspect there is a computer program comprising instructions which, when executed on at least one processor of a security system, cause the security system to carry out a method according to the first aspect.

According to a fifth aspect there is a carrier containing a computer program according to the fourth aspect, wherein the carrier comprises one of an electronic signal, optical signal, radio signal or computer readable storage medium.

According to a sixth aspect there is a computer program product comprising non transitory computer readable media having stored thereon a computer program according to the fourth aspect.

As noted above, current recovery practices tend to focus on detecting and patching system vulnerabilities in order to prevent a recovery scenario from occurring in the first place. In the event that a recovery scenario occurs, current recovery practices then focus on damage limitation and system recovery from backups.

Embodiments herein focus instead on performing pre-emptive actions in scenarios where there is a high risk of a recovery scenario occurring, or as a recovery scenario is unfolding, so as to manage the recovery scenario as it progresses, and better prepare the computing system for improved recovery with less damage.

As described above, aspects herein involve assessing ongoing risks and performing pre-emptive actions ahead of and/or during the progression of recovery scenarios. By performing actions in advance of a recovery scenario, or as the recovery scenario unfolds, actions may be taken to specifically manage the particular type of recovery scenario, thus reducing damage to the computing system and/or increasing effectiveness of recovery of the computing system following the recovery scenario. The solutions herein may thus sit in between what has gone before: e.g. instead of being purely defensive in order to prevent a recovery scenario, or purely reactive after a recovery scenario has happened, embodiments herein may be performed after defensive mechanisms have failed, but before system failure, in order to mitigate an emerging recovery scenario. Generally, the systems and methods herein provide for automated security recovery by minimizing and flattening the impact of recovery situation by automating reconstitution actions. Some embodiments further act to prevent misuse of critical or otherwise sensitive data in the event of a recovery scenario, for example due to a third party attack on the computing system, or an internal security breach.

### BRIEF DESCRIPTION OF THE DRAWINGS

For a better understanding and to show more clearly how embodiments herein may be carried into effect, reference will now be made, by way of example only, to the accompanying drawings, in which:

FIG. 1 illustrates an example security system according to some embodiments herein;

FIG. 2 shows an example method according to some embodiments herein;

FIG. 3 show an example process according to some embodiments herein;

FIG. 4 shows example pre-emptive actions according to some embodiments herein;

FIG. 5 shows example pre-emptive actions according to some embodiments herein;

FIG. 6 shows example pre-emptive actions according to some embodiments herein;

FIG. 7 shows an example system according to some embodiments herein;

FIG. 8 shows an example process according to some embodiments herein;

FIG. 9 illustrates a carrier of a computer program; and

FIG. 10 illustrates a computer program product according to some embodiments herein.

### DETAILED DESCRIPTION

The disclosure herein relates to security systems for computing systems such as IT systems or telecommunications systems. More generally, any computing system e.g. comprising servers, or virtual servers that run software programs and/or store data.

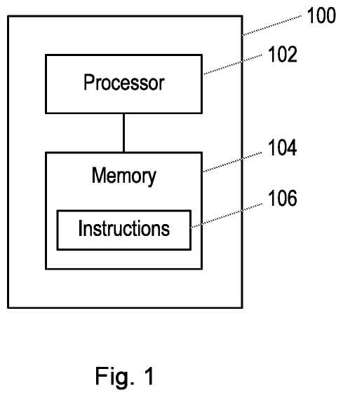

FIG. 1 shows an example apparatus in the form of a security system 100 according to some embodiments herein. The security system 100 is configured (e.g. adapted, operative, or programmed) to perform any of the embodiments of the method 200 as described below.

The security system 100 comprises a processor (e.g. processing circuitry or logic) 102. The processor 102 may control the operation of the security system 100 in the manner described herein. The processor 102 can comprise one or more processors, processing units, multi-core processors or modules that are configured or programmed to control the security system 100 in the manner described herein. In particular implementations, the processor 102 can comprise a plurality of computer programs and/or hardware modules that are each configured to perform, or are for performing, individual or multiple steps of the functionality of the security system 100 as described herein.

The security system 100 comprises a memory 104. In some embodiments, the memory 104 of the security system 100 can be configured to store a computer program 106 with program code or instructions that can be executed by the processor 102 of the security system 100 to perform the functionality described herein. Alternatively or in addition, the memory 104 of the security system 100, can be configured to store any requests, resources, information, data, signals, or similar that are described herein. The processor 102 may be configured to control the memory 104 to store any requests, resources, information, data, signals, or similar that are described herein.

It will be appreciated that the security system 100 may comprise one or more virtual machines running different software and/or processes. The security system 100 may therefore comprise one or more servers, switches and/or storage devices and/or may comprise cloud computing infrastructure or infrastructure configured to perform in a distributed manner, that runs the software and/or processes.

It will be appreciated that the security system 100 may comprise other components in addition or alternatively to those indicated in FIG. 1. For example, in some embodiments, the security system 100 may comprise a communications interface. The communications interface may be for use in communicating with other apparatuses e.g. via a communications network, (e.g. such as other physical or virtual computing nodes). For example, the communications interface may be configured to transmit to and/or receive from nodes or network functions requests, resources, information, data, signals, or similar. The processor 102 of security system 100 may be configured to control such a communications interface to make/receive such transmissions.

The security system 100 may be implemented in (e.g. form part of) a communications network. In some embodiments herein, the security system 100, may be implemented in a management layer/Operations Support System layer of a communications network.

More generally, the security system 100 may be implemented in any node/network device of a communications network. For example, the security system 100 may comprise any component or network function (e.g. any hardware or software) in a communications network suitable for performing the functions described herein. Examples of nodes include but are not limited to core network functions such as, for example, core network functions in a Fifth Generation Core network (5GC). It is realized that the security system 100 may be included as a node/device in any future network, such as a future 3GPP (3^{rd} Generation Partnership Project) sixth generation communication network, irrespective of whether the security system 100 would there be placed in a core network or outside of the core network.

A communications network or telecommunications network may comprise any one, or any combination of: a wired link (e.g. ASDL) or a wireless link such as Global System for Mobile Communications (GSM), Wideband Code Division Multiple Access (WCDMA), Long Term Evolution (LTE), New Radio (NR), WiFi, Bluetooth or future wireless technologies. The skilled person will appreciate that these are merely examples and that a communications network may comprise other types of links. A wireless network may be configured to operate according to specific standards or other types of predefined rules or procedures. Thus, a wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Generally (as will be described in more detail below), the security system 100 is for use in monitoring a computing system with respect to a recovery scenario from which the computing system would require recovery. For example, the security system may be used to secure the computing system against the recovery scenario. The security system 100 may be used to detect and action a possible, future recovery scenario for the computer system.

Briefly the security system 100 is configured to determine a risk that the computing system will undergo the recovery scenario; and perform one or more pre-emptive actions so as mitigate against occurrence of the recovery scenario, wherein the pre-emptive actions comprise: a) adding a security control to compensate for the recovery scenario; b) creating an image of part of the computing system; c) storing artifacts of the computing system in a storage space that is separate from the computing system; d) encrypting or deleting data from the computing system; and/or e) disabling one or more components in the computing system. In other words, a pre-emptive action performed by the security system 100 may be one or more of the pre-emptive actions a)-e).

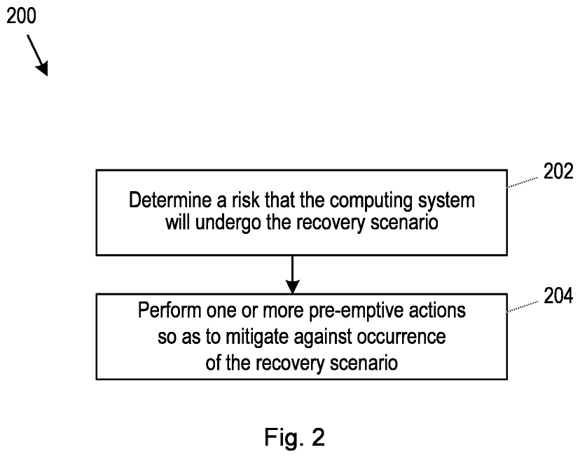

Turning now to FIG. 2, there is a method 200 for use in monitoring a computing system with respect to a recovery scenario from which the computing system would require recovery. The method 200 is computer implemented. Briefly, in a first step 202, the method 200 comprises: determining a risk that the computing system will undergo the recovery scenario. In a second step 204 the method comprises, responsive to the determined risk, performing one or more pre-emptive actions so as mitigate against occurrence of the recovery scenario. The pre-emptive actions comprise: a) adding a security control to compensate for the recovery scenario; b) creating an image of part of the computing system; c) storing artifacts of the computing system in a storage space that is separate from the computing system; d) encrypting or deleting data from the computing system; and/or e) disabling one or more components in the computing system.

The method 200 may be performed by an apparatus such as the security system 100 described above. Generally, the method 200 may be performed on system recovery indicators obtained from a computing system in real-time as part of a security procedure to monitor the computing system with respect to recovery scenarios.

A computing system may comprise one or more servers that store data and/or run processes. A computing system may comprise virtual components, for example, one or more virtual servers, virtual machines (VMs), application containers, Virtual Network Function (VNFs) or Cloud-Native Network Functions (CNF).

A computing system may be used by users to run software packages and/or access data held on the computing system. The computing system may be associated with an organisation such as a government organisation, business or home. The computing system may store data and provide access to services for users of the organisation associated with the organisation. In some examples, the computing system may be an Information Technology (IT) system or a node in a communications network, as described above.

The method 200 may be performed on a computing system as part of a security procedure. E.g. as part of ongoing security monitoring. The method 200 may be used to secure the computing system against occurrence or the effects of recovery scenarios.

As used herein, a recovery scenario comprises any situation, action or incident which results in the computing system requiring (e.g. needing) recovery. In other words, a scenario from which a recovery procedure will be performed. Recovery scenarios may arise maliciously or non-maliciously. A recovery scenario may compromise (e.g. “crash”) the computing system or a part of the computing system, e.g. by rendering part of the computing system inoperable or inaccessible.

Recovery scenarios may be caused by a wide range of factors. For example, a recovery scenario may be caused by: an external (e.g. third party) attack on the computing system, e.g. a malicious attack by a person unauthorised to use the computing system; an internal security breach (e.g. caused by a malicious user of the computing system); a system failure of the computing system, e.g. such as a hardware or software failure; an adverse environmental condition which will, will likely or is affecting the computing system; an uncontrolled system change in or related to the computing system; and/or a human error which is or is likely to affect the computing system. In this sense, uncontrolled system changes may comprise, for example, an authorization of changes of software or software settings, introduction of a poorly tested software package, and/or transferral of software in an uncontrolled manner between development/staging and production sites. The skilled person will appreciate that these are merely examples, and that the methods described herein may be applied to any recovery scenario from which the computer system would require recovery.

As used herein, recovery may comprise restoring the computing system in order to make it accessible and/or operable. Recovery may comprise restoring the computing system to (or as close as possible to) its previous operating state.

In more detail, in step 202 the method comprises determining a risk that the computing system will undergo the recovery scenario. The risks described herein may take various forms. For example, the risk may be calculated as a percentage likelihood of the event occurring, multiplied by a measure of impact if the recovery scenario were to occur. Different recovery scenarios may have different impact values, dependent, for example, on the extent to which the computing system can be recovered following the recovery scenario. Impact may be determined for different types of recovery scenarios, by a human engineer, for example. Thus, in some embodiments, the step of determining a risk that the computing system will undergo the recovery scenario comprises: predicting a likelihood (e.g. probability) that the computing system will undergo the recovery scenario from system recovery indicators, wherein the risk is determined as a function of the predicted likelihood and an estimation of impact if the recovery scenario were to occur. As previously noted, the function may be a multiplication of likelihood and impact, or alternatively some other weighted combination of likelihood and impact.

It will be appreciated however that risks may be defined differently in different security systems, for example, in some examples, the risk may be represented by a numerical score indicating the likelihood or probability that the recovery scenario will occur. In other examples the risk may be classified, for example, as “low risk”, “medium risk” or “high risk”. The skilled person will appreciate that these are merely examples and that other ways of presenting relative risks may equally be applied.

Generally, risks may be determined (e.g. estimated or calculated) from system recovery indicators. The method 200 may thus further comprise (e.g. as part of step 202) obtaining system recovery indicators for the computing system. Obtaining the system recovery indicators may be performed by receiving or retrieving the system recovery indicators from the computing system. For example, the security system 100 may send requests to the computing system (or other entity monitoring the computing system) to obtain the system recovery indicators.

System recovery indicators may be thought of as marks or manifestations of a potential recovery scenario in the system. System recovery indicators may comprise any information or data indicative of change, instability or unusual behaviour in a computing system that might be indicative of system compromise. For example, the system recovery indicators may comprise data representing system access patterns; traffic flow patterns through the system; and/or indicators of system vulnerabilities. The system recovery indicators obtained may be in any format, for example, numerical, text, image etc.

Examples of system recovery indicators include but are not limited to indicators related to:
Initial Access e.g. failing admin logins and password failures within specific timeframe
Defence Evasion e.g. audit logging changes in several nodes, inbound traffic appearing in a port where usually there is no/limited amount of traffic,
Discovery e.g. increasingly failing technical security controls in the network, high number of unpatched known vulnerabilities in a system, high CVE scores for known unpatched vulnerabilities, information available in public hacker sources
Lateral movement e.g. indicators relating to the detection of techniques that a cyberattacker uses, after gaining initial access, to move deeper into a network in search of sensitive data and other high-value assets. Lateral movement indicators include but are not limited to configuration or file integrity breaks in one or more nodes (e.g. within a specific timeframe), changes in patterns of behaviour of privileged users which might indicate that the cyberattacker is using the privileged user account instead of the intended user, indications of new (or unauthorised) user accounts having been created (e.g. by an attacker), and indications that information relating to known vulnerabilities has been exploited.
Collection e.g. outbound traffic in a port where usually there is no/limited amount of traffic
Life-cycle status e.g. software release is 6 months or older in a system, time of latest configuration change, rate of patching

Further examples are described as part of the MITRE™ ATT&ACK™ framework (see MITRE technical report document MT R 17 02 02). The skilled person will appreciate that these are merely examples however and that many different types of system recovery indicators may be used.

System recovery indicators (e.g. values or other data indicative thereof) may obtained (or collected) from the computing system. For example, from log data. Step 202 may thus comprise sending a message to one or more components of programs in the computing system, to request the component or program provide the system recovery indicators.

Step 202 may further comprise receiving messages comprising system recovery indicators from one or more components or programs in the computing system.

Likelihood or probability values describing the likelihood of different types of recovery event may be determined from system recovery indicators in different ways. For example, through profile analysis. Different recovery scenarios typically unfold in a predictable manner, for example, particular system recovery indicators may appear, or their values may begin to change before other system recovery indicators, e.g. in a sequence. As such, different types of system recovery indicators may typically be associated with the early stages of an emerging recovery scenario, whilst others may be associated with the late stages of a recovery scenario. Thus, different recovery scenarios may be thought of as having different profiles or signatures as the values of different system recovery indicators evolve as a recovery scenario unfolds.

In some examples, machine learning may be used to predict either a risk level associated with occurrence of a recovery scenario or a likelihood of a recovery scenario occurring that might be used to calculate a risk value as described above.

For example, a model may be trained using a machine learning process to take as input values of system recovery indicators and output an estimation of risk (or likelihood) that the computing system will undergo the recovery scenario. Such a machine learning model may have been trained using supervised learning. For example, the model may have been trained using training data comprising a plurality of training examples, each training example comprising: example values of the plurality of system recovery indicators obtained for an example computing system, and ground truth risk (or likelihood) values that said example computing system (having the example system recovery indicators) will undergo the recovery scenario.

In such examples, the training data comprises example inputs and ground truth likelihood values which represent the “correct” outputs for each example input. A training dataset may be compiled by a human-engineer, for example, by manually assessing the training examples and assigning the ground truth label to each example. In other examples, a training dataset may be labelled in an automated (or semi-automated manner) based on predefined criteria defined by a human engineer.

Generally, training data can be obtained following occurrence of recovery scenarios in the example computing systems. For example, as part of a post recovery activity identified system recovery indicators, and ground truth labels can be provided to the model for further training. In this way, the model can be continuously updated on emerging recovery scenarios in real computing systems.

The skilled person will be familiar with machine learning processes and machine learning models that can be trained using training data to predict outputs for given input parameters.

A machine learning process may comprise a procedure that is run on data to create a machine learning model. The machine learning process comprises procedures and/or instructions through which training data, may be processed or used in a training process to generate a machine learning model. The machine learning process learns from the training data, for example the process may be fitted to the training data. Machine learning processes can be described using math, such as linear algebra, and/or pseudocode, and the efficiency of a machine learning process can be analyzed and quantized. There are many machine learning processes, such as e.g. processes for classification, such as k-nearest neighbors, processes for regression, such as linear regression or logistic regression, and processes for clustering, such as k-means. Further examples of machine learning processes are Decision Tree algorithms and Artificial Neural Network algorithms. Machine learning processes can be implemented with any one of a range of programming languages.

The model, or machine learning model, may comprise both data and procedures for how to use the data to e.g. make the predictions described herein. The model is what is output from the machine learning (e.g. training) process, e.g. a collection of rules or data processing steps that can be performed on the input data in order to produce the output. As such, the model may comprise e.g. rules, numbers, and any other algorithm-specific data structures or architecture required to e.g. make predictions.

Different types of models take different forms. Some examples of machine learning processes and models that may be used herein include, but are not limited to: linear regression processes that produce models comprising a vector of coefficients (data) the values of which are learnt through training; decision tree processes that produce models comprising trees of if/then statements (e.g. rules) comprising learnt values; or neural network models comprising a graph structure with vectors or matrices of weights with specific values, the values of which are learnt using machine learning processes such as backpropagation and gradient descent.

In some embodiments, the model may be a classification model, which outputs the risk/likelihood in the form of one or more predetermined classes (for example such as “low”, “medium” or “high” likelihood). In other embodiments, the model may be a regression model that outputs a likelihood value on a continuous scale. For example, from 0 to 1.

In some embodiments, a decision tree or a random forest-based classifier may be used. Such models are well suited to step 202 herein as they are good for processing multi feature inputs (collected from the security domain) where output is given by the result of a security analyst. Moreover, tree-based models are good not only to find relations in feature spaces but also non-linear relations as well. The skilled person will be familiar with decision trees and random forest models, which are described in detail in the papers: Quinlan (1986) entitled: “Induction of decision trees” Machine Learning volume 1, pages 81-106 (1986); and Breiman (2001) entitled “Random Forests”; Mach Learn 45 (1): 5-32. The skilled person will appreciate that a wide range of other types of machine learning models may equally be used, including but not limited to deep neural network models.

As an example, a decision tree may be set up using a standard ML model library such as the sci-kit-learn library which is described in the paper “Scikit-learn: Machine Learning in Python”, by Pedregosa et al., JMLR 12, pp. 2825-2830, 2011. A decision tree may be trained, for example, following the principles of classifier.fit ( )—from scikit-learn, see for example, chapter 1.10 of the scikit-learn 0.23.2 documentation. Turning back to FIG. 2 and the method 200, after determining a risk that the computing system will undergo the recovery scenario, in step 204, responsive to the determined risk, the method 200 comprises performing one or more pre-emptive actions so as mitigate against occurrence of the recovery scenario. The pre-emptive actions comprise: a) adding a security control to compensate for the recovery scenario; b) creating an image of part of the computing system; c) storing artifacts of the computing system in a storage space that is separate from the computing system; d) encrypting or deleting data from the computing system; and/or e) disabling one or more components in the computing system.

Generally, this step is to automate technical recovery, minimize the number of severe recovery situations, flatten the impact of the recovery situation, prevent misuse of critical information, shorten the actual outage times and thus enable faster more accurate recovery leading to greater trust in computing systems.

### Option a): Adding a Security Control to Compensate for the Recovery Scenario

The skilled person will be familiar with security controls, but in brief, security controls are safeguards or countermeasures to avoid, detect, counteract, or minimize security risks to the computing system. Security controls fall into categories such as: technical, administrative and physical. Security controls are e.g., safeguards or countermeasures for a computing system that are primarily implemented and executed by the computing system through mechanisms contained in the hardware, software, or firmware components of the system. Technical controls are configurable security related parameters such as password settings, logon procedures, system notifications, SSH configuration, user privilege settings, session management, authentication parameters, confidentiality and integrity parameters. Further examples include but are not limited to controls for password length, setting access control rights, and/or achieving encryption for sensitive data.

New controls may be added, for example, to the server in production, to security images or to the information technology network, e.g. by complementing new Firewall (FW) rules.

The controls added may depend on the particular recovery scenario that has been predicted to occur. For example, if there is a risk of a recovery scenario occurring due to existing login passwords that can be cracked, then compensating controls may be added to require more complex passwords, or to tighten rules regarding the number of invalid login attempts that are permitted.

As another example, if there is a risk of a recovery scenario related to disclosure of sensitive data when data is in transit, a compositing control may be added to provide encryption for the data when in transit, for instance, by enforcing Transport Layer Security (TLS) protection.

As another example, if there is a risk of a recovery scenario due to unauthorized or unintended modification of system configuration data, a compositing control may be added to provide strong access rights for a limited number of administrators. This may be further configured to grant the access rights for a certain (e.g. limited) time period.

Generally, step 204 may comprise adding compensating security controls to the computing system, to minimize or flatten the disruptive impact of a security scenario.

A database of recovery scenarios and corresponding security controls may be maintained e.g. by an Engineer and used to determine appropriate controls to be applied for different recovery scenarios.

Alternatively or in addition, a machine learning model (such as the machine learning model described above, for use in step 204) may be further trained to output appropriate security controls for the predicted recovery scenario. E.g. a model trained using a machine learning process may further be trained to predict actions that can be taken to prevent the recovery scenario from taking place and/or that improve recovery outcomes. A machine learning model may be trained in this manner by providing ground truth labels comprising appropriate security controls for the predicted recovery scenario. The model can then be trained to output the appropriate security controls as a second output.

### Option b): Creating an Image of Part of the Computing System

Recovery images for servers may be enhanced and updated in order to be used for re-instantiation of the server into approved security state following a recovery scenario. For example, the immutability of container images may be verified. The security system may maintain and prepare on-line recovery image for a computing system (e.g. server) in order to quickly re-build and restore the desired and approved security state in case of a recovery scenario. The recovery image may be continuously improved in response to emerging risks of recovery scenarios, and stored in a recovery image database for further usage in an emergency, e.g. when a recovery scenario cannot be prevented.

Recovery images for particular parts of the computing system that are at risk may be preferentially updated over other parts that are not judged to be at risk, thus ensuring that the most detailed images are taken of parts of the computing system most at risk of undergoing the recovery event.

This provides fail safe functionality during a recovery scenario, ensuring that critical information residing in the server cannot be exploited during or after the disruption.

The skilled person will be familiar with security images. Examples of different types of software (SW) images include, for example, disk images, Virtual Machine (VM) images, container images, docker images and microservices.

Various images are described in the National Institute of Standards and Technology (NIST) Special Publication 800-190 entitled, “Application Container Security Guide” by Souppaya, Morello and Scarfone; see for example, chapter 2.3 on Container Technology Architecture. See also NIST publication 800-125 entitled Guide to Security for Full Virtualization Technologies” by Scarfone, Souppaya and Hoffman. Option c): storing artifacts of the computing system in a storage space that is separate from the computing system

This may comprise, for example, storing/copying sensitive data into a separate storage space in order to ensure that data is not lost in a security scenario. Data used for forensics purposes (e.g. for post-recovery analysis to determine the cause of the recovery scenario) may also be copied to a separate storage space. This introduces dynamic, scale safe technical mechanisms for network services, ensuring critical information residing in the network servers cannot be exploited during or after the disruption.

Option d): Encrypting or Deleting Data from the Computing System

For example, this may comprise encrypting or destroying sensitive data, to prevent misuse of it, preserving credential stores and access tokens and regenerating compromised ones, replacing compromised components with clean software versions and moving it into scale safe environment waiting for a new server instance to be scaled in.

In this way there is provided a self-destruct mechanism to destroy critical information or render itself inoperable in emergency circumstances if required to protect from sensitive information leakage. This may be used to protect against third party attacks on the computing system.

As an example, data on the computing system may be labelled or tagged to indicate that it is sensitive and that it should be encrypted or deleted in the event that a risk is determined of particular types of recovery scenario occurring.

Alternatively or in addition, machine learning may be used to predict which information on a server is of a sensitive nature and should be encrypted or deleted.

### Option e): Disabling One or More Components in the Computing System

Disablement may be used to render the system inoperable in emergency circumstances, e.g. to protect against mis-use or sensitive information leakage. This may be used to protect against third party attacks or internal attacks on the computing system.

As an example, external media/storage may be used to store sensitive data. In such an example, option e) may comprise disabling one or more ports to external media components from the computing device.

In another example, option e) may comprise instructing the computing system (or a component of the computing system) to shut down and re-start (or boot) in a “rescue” or “emergency mode” (which may also be referred to as a safe mode). In this mode the device is booted with minimal environment only. In this way, sensitive data and/or components may be protected.

In some embodiments, the pre-emptive actions are selected from the options a), b), c), d) and e) above according to the type of the recovery scenario that is predicted, so as to mitigate against said type of recovery scenario. In other words the pre-emptive actions may be targeted at the specific recovery scenario risks.

Generally, as described above, the pre-emptive actions may be selected using, e.g. a database comprising recovery scenarios and appropriate pre-emptive actions that should be performed. Such a database may be pre-configured by a user.

Alternatively or in addition, a machine learning model (such as the machine learning model described above, for use in step 204) may be further trained to output appropriate security controls for the predicted recovery scenario. E.g. a model trained using a machine learning process may further be trained to predict actions that can be taken to prevent the recovery scenario from taking place and/or that improve recovery outcomes. As noted above, a machine learning model may be trained in this manner by providing ground truth labels comprising appropriate security controls for the predicted recovery scenario. The model can then be trained to output the appropriate security controls as a second output.

Different actions may be performed dependent on risk level. For example, the pre-emptive actions may be selected from the options a), b), c), d) and e) dependent on the determined risk (e.g. risk level). Put another way, when there are increasing numbers of system recovery indicators with values indicative of an emerging or approaching recovery scenario (e.g. one or more servers in the computing system are moving into unstable state), risk for disruption is evaluated indicating the level reconstitution actions required. Based on the risk rating, different pre-emptive actions are performed.

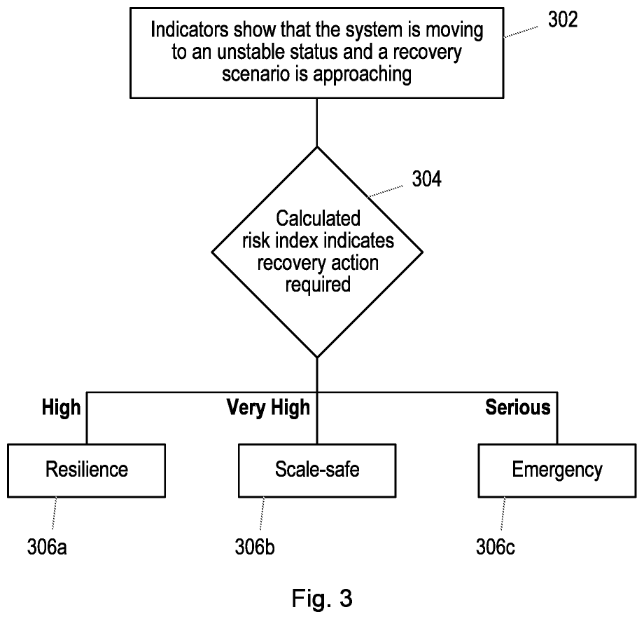

This is illustrated in FIG. 3 which illustrates an embodiment of the method 200. In this embodiment, step 202 comprises, in a first block 302, obtaining system recovery indicators for the computing system, and determining that the system is moving to an unstable status (this may be based e.g. on profile analysis of the system recovery indicators, as described above). In step 304, the method then comprises determining a risk that the computing system will undergo the recovery scenario, and if the risk indicates a recovery scenario is likely (and a recovery action will need to be performed in order to recover the computing system), then responsive to the determined risk, one or more pre-emptive actions 306a; 306b; 306c are performed (as described with respect to step 204 above) so as mitigate against occurrence of the recovery scenario.

In the example of FIG. 3, in step 204, pre-emptive actions are performed 306a; 306b; 306c according to three risk levels as follows:
Resilience actions 306a for category 1 (“high”) risks-adding compensating controls e.g. encrypting sensitive data, add new security controls to the server in production and container images or add new security functions to the information technology network, e.g. by complementing new FW rules.
Scale-safe actions 306b for category 2 (“very high”) risks-transferring service to more restricted areas, isolate the server into safer environment (“scale safe”), tightening the perimeter security and isolation mechanisms with separate security functions and adjusted firewall rule sets, router access control lists, preparing server images which include updated SW components and additional security controls to be scaled in.
Emergency actions 306c for category 3 (“serious”) risks-apply extra security controls and eliminate components ensuring that the critical information residing in the server cannot be exploited during or after the disruption. This may include actions like encrypting sensitive data, destroying sensitive data to prevent misuse of it, preserving credential stores and access tokens and regenerating compromised ones.

In this way, as shown in FIG. 3, different actions may be performed for different levels of risk. In this example, common actions performed in all three categories above are storing artifacts e.g. sensitive data stored into a separate storage space (option c above), verifying immutability of container images (option b above), and collection and storage of data used for forensics purposes (option c above).

The skilled person will appreciate that FIG. 3 is merely an example and that pre-emptive actions may be performed on the basis of different risk categories to those described above.

For example, returning to step 204 in FIG. 2, more generally, the step of performing 204 one or more pre-emptive actions may be performed responsive to the risk being above a first pre-determined threshold risk or risk level. The first predetermined risk level may correspond to “high” risk scenarios. The first predetermined risk level may correspond to the threshold level set in the security system for performing pre-emptive actions (e.g. the lowest risk that prompts pre-emptive actions to be performed according to step 204 of the method 200).

In some embodiments, the pre-emptive actions comprise option a) (e.g. adding a security control to compensate for the recovery scenario) when the risk is above the first pre-determined threshold risk.

As an example, in “high” risk cases, maintaining and improving resilience is the objective. The software (SW) packages in the server as such remain intact but compensating controls may be added to the server running in production. Compensating controls provide an extra protection for the system in production environment without need to scale server to “scale safe” side. Compensating controls can be for instance, adding extra Firewall rules to the system, adding encryption for transport protocols or data at rest.

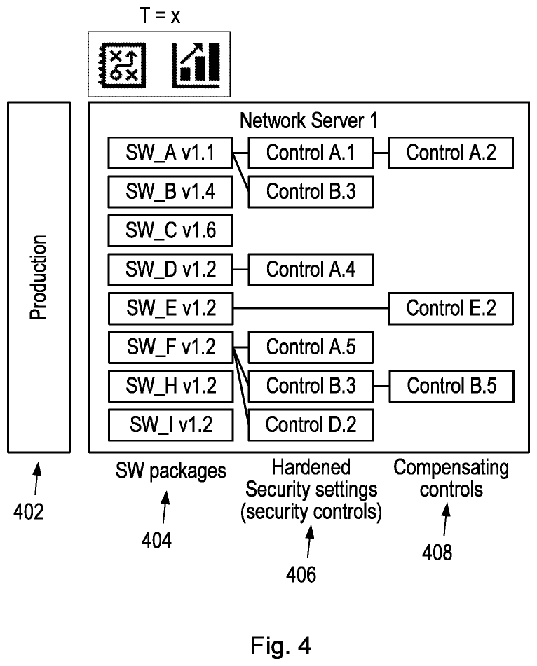

This is illustrated in FIG. 4 whereby for SW packages 404 (illustrated as SW_A v1.1, SW_B v1.4, etc) with Security controls 406 (illustrated in the figure as Control A. 1, B.3, etc), when a “high” risk case is identified, compensating controls 408 are added such as extra firewall rules or encryption protection for data in rest or in transit are added to the system to better protect the system against the recovery scenario. As illustrated in FIG. 4, these may be added directly to the production environment 402 (e.g. the live computing system).

In some embodiments, the pre-emptive actions comprise option b) (e.g. creating an image of part of the computing system) when the risk is above a second pre-determined threshold risk. The second predetermined risk level may correspond to “very high” risk scenarios. The second predetermined risk level may correspond to a higher risk than the first predetermined risk threshold. When the risk is above the second predetermined risk threshold, both the actions for the high risk and very-high risk brackets may be performed.

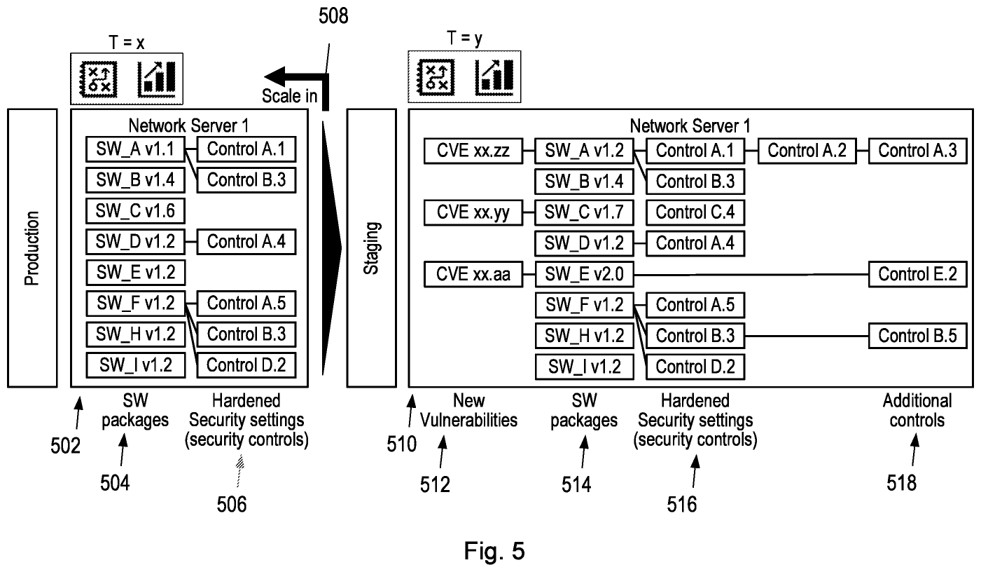

As an example, in a very high risk case, ensuring scale-safe may be the main objective. If it is foreseen that a recovery situation is approaching and in order to flatten the impact, more secure image(s) of the server(s) may be proactively built in the background. Secure images are stored in a database (DB). FIG. 5 shows a production (e.g. “live”) computing system 502, illustrating software packages 504 and security controls 506 in the production environment. An image 510 of the computing system is maintained in a staging environment. As illustrated in FIG. 5, in the very high case e.g. when new severe vulnerabilities and other weaknesses are identified 512, these are addressed by creating a new server image in the form of updated SW packages 514 and/or by adding security controls 516 to the updated image to be used in scale-safe situation.

In addition, new compensating controls 518 can be added to existing SW sub-packages in the server images. These new server images pro-actively build in the background and are stored in a Recovery Image DB. They are used to quickly re-build and scale-safe (illustrated by arrow 508) a new version of the server in production, following a recovery scenario.

In some embodiments, the pre-emptive actions comprise options d) and/or e) (e.g. encrypting or deleting data from the computing system and/or disabling one or more components in the computing system) when the risk is above a third pre-determined threshold risk. The third predetermined risk level may correspond to “emergency” risk scenarios, e.g. where a recovery scenario (e.g. system crash) is rapidly approaching. The third predetermined risk level may correspond to a higher risk than the second and/or the first predetermined risk threshold. When the risk is above the third predetermined risk threshold, the actions for the high risk, very-high and emergency risk brackets may be performed.

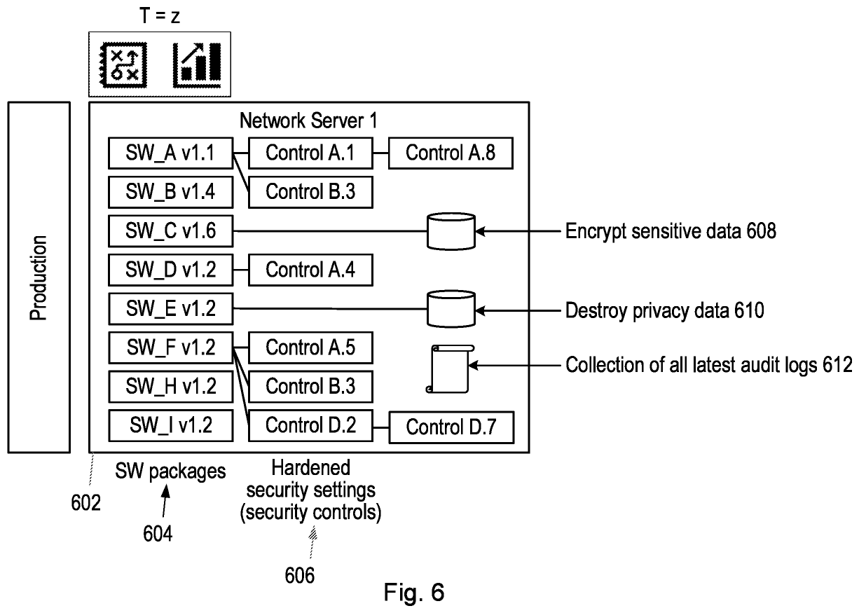

As an example, in an emergency case, when a recovery scenario (e.g. crash) is evident, the objective may be applying final crash-safe mechanisms to the server. This is illustrated in FIG. 6 which shows a production server 602 for which it has been determined that there is an “Emergency” e.g. imminent risk of a recovery scenario occurring. In this situation extra security controls 606 have already been added to the SW packages 604 as part of previous risk level actions, and some critical components may be eliminated to ensure that the critical information residing in the server cannot be exploited during or after the disruption. This may include actions based on data classification like encrypting sensitive data 608 or destroying privacy data 610 to prevent misuse of it. In emergency risk scenarios, important data is preserved to be used later for forensics purposes. These activities can contain e.g. storing the latest security and audit logs 612, encrypting them with special emergency crypto keys, capturing the server's volatile memory images and generating “logical” copy of data. In may also render some components temporary inoperable to avoid them used during disruption.

Thus, in this way, there is provided a method in a security system for performing pre-emptive actions ahead of a recovery scenario, or as a recovery scenario is emerging, in order to mitigate or reduce the impact of the recovery scenario. Furthermore, the method is able to respond to the severity or urgency of the recovery scenario in order to perform actions best able to secure the computing system, given the predicted severity and time available in which to perform actions.

As noted above, the method 200 may be performed in real-time in an iterative manner in order to monitor for and deal with emerging recovery scenarios. Thus, in some embodiments, the method may comprise repeating the steps of: determining (202) a risk that the computing system will undergo the recovery scenario; and responsive to the determined risk, performing 204 one or more pre-emptive actions so as mitigate against occurrence of the recovery scenario; in an iterative manner.

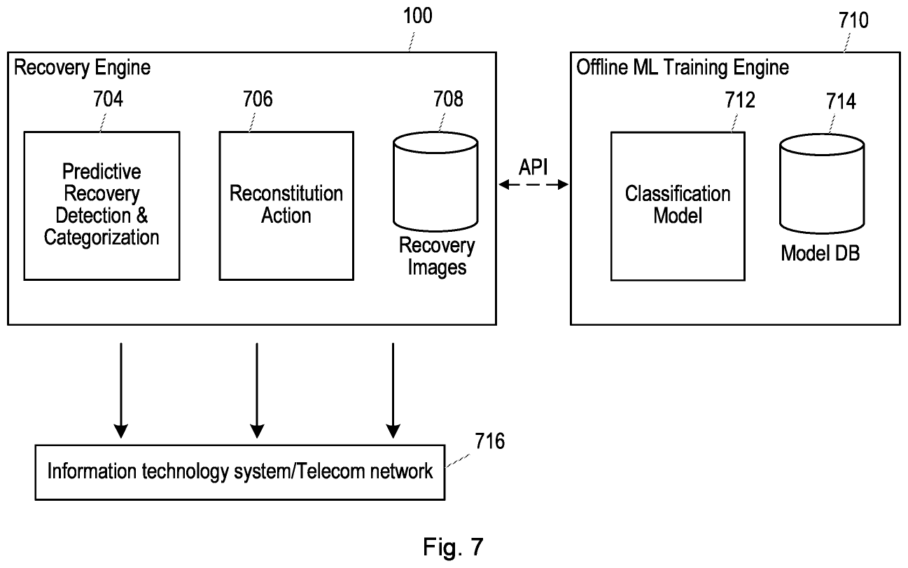

Turning now to FIG. 7, which illustrates an example security system 100 for monitoring a computing system 716 with respect to a recovery scenario from which the computing system would require recovery. The security system 100 may comprise a processor 102, a memory 104 and a computer program 106, as described above with respect to FIG. 1. For example, a memory 104 may comprise instructions that when run on a processor 102, perform the actions described below.

In this example system, there is also an Offline Machine Learning Training Engine 710 that provides a classification model 712 from a database of models 714 to the security system by means of an application programming interface (API). The security system is for use in securing a computing system 716 such as an IT system or telecoms network, against a recovery scenario from which the computing system would require recovery.

In this embodiment, a predictive Recovery Detection & Categorisation Module 704 performs step 202 of the method 200 as described above, and determines a risk that the computing system will undergo a recovery scenario. In this embodiment, the risk is determined using a machine learning (ML) model (downloaded from the offline ML Training Engine 710) that takes as input system recovery indicators and outputs a risk level. If a model suitable for taking the obtained system recovery indicators as input is not available to the Recovery Detection & Categorisation Module 704, then the security system 100 requests a model from the Offline Training Engine 710 using an Application Programming Interface (API). In response to such a request, the Offline Training Engine may send a trained model to the Recovery Detection & Categorisation Module 704 if available, or else the Offline Training Engine 710 will train a new model, e.g. based on historical data and earlier observed indicators and labels, which may be provided by a (human) engineer (if needed) and send the updated classification model to the Recovery Detection & Categorisation Module 704.

The Recovery Detection & Categorisation Module 704 uses the trained model to determine the risk that the computing system will undergo the recovery scenario. If the risk is above a threshold risk level, then a Reconstitution Action module 706 performs step 204 of the method 200 described above, and performs one or more pre-emptive actions so as mitigate against occurrence of the recovery scenario. As described above, the pre-emptive actions may comprise: a) adding a security control to compensate for the recovery scenario; b) creating an image of part of the computing system; c) storing artifacts of the computing system in a storage space that is separate from the computing system; d) encrypting, or deleting data from the computing system; and/or e) disabling one or more components in the computing system. Thus, the Reconstitution Action module 706 determines, based on system recovery indicators, the risk (and severity) of the potential approaching recovery situation, and what type of actions should be taken to prevent or mitigate the recovery scenario.

Where the pre-emptive actions comprise creating an image of part of the computing system, the image may be stored in a database of Recovery Images 708. Recovery Image DB is used for storing server images and artifacts that are proactively prepared and collected for recovery situations and to re-instantiate a trusted server into the infrastructure.

The skilled person will appreciate that the system illustrated in FIG. 7 is an example only and that the functionality described in respect thereof may be performed by different modules or different combinations of modules, to those described above.

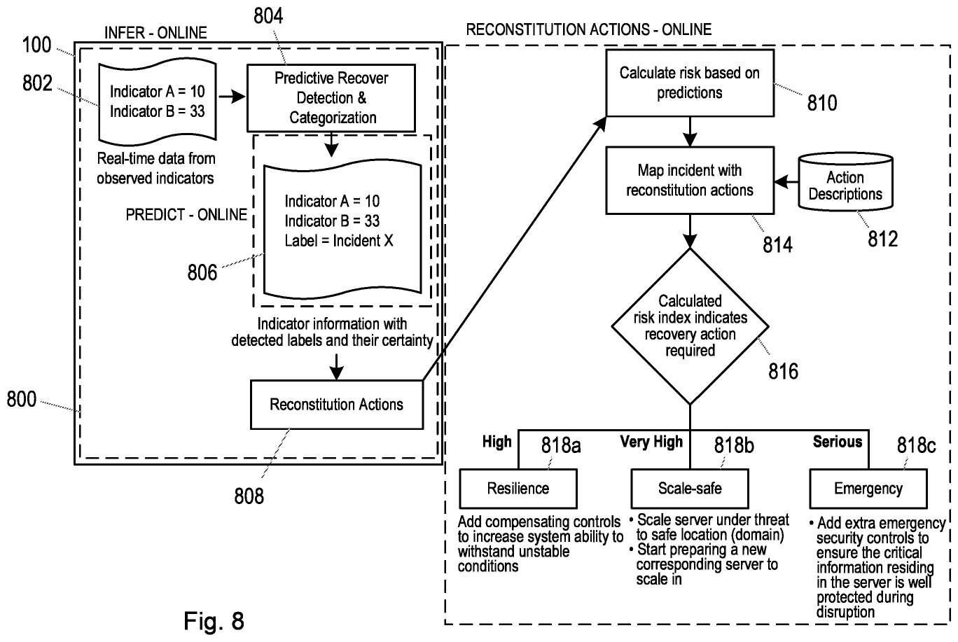

Turning now to FIG. 8, there is illustrated an example method in a security system 100 according to some embodiments herein. This method may be performed, for example, by the Recovery Detection & Categorisation Module 704 illustrated in FIG. 7, or the processor 102 of the security system illustrated in FIG. 1.

In this embodiment, system recovery indicators 802 are obtained from a computing system and these are used by a Predictive Recover Detection & Categorisation module 804 to predict an emerging recovery scenario 806. A Reconstitution Actions module 808 determines 810 a risk that the computing system will undergo the recovery scenario (e.g. a risk associated with the recovery scenario).

If the risk is above a threshold, then module 808 uses a database of action descriptions 812 to determine pre-emptive actions so as mitigate against occurrence of the recovery scenario, in other words, module 808 maps 814 recovery or reconstitution actions to the recovery scenario.

Dependent on the level of risk, different pre-emptive actions are performed. In the example of FIG. 8 the pre-emptive actions 818a; 818b; 818c are selected in step 816 according to the scheme set out above with respect to FIG. 3. The detail above with respect to FIG. 3 will be understood to apply equally to FIG. 8.

Thus, there is a method of monitoring a computing system with respect to recovery scenarios. The system provides automated security recovery, by minimizing and flattening the impact of recovery scenarios through automated recovery/reconstitution actions. The skilled person will appreciate that FIG. 8 is an example only and that the steps and functionality therein may be performed by different modules and/or in a different order to that presented therein.

Turning now to other embodiments, there is provided a computer program product comprising a computer readable medium, the computer readable medium having computer readable code embodied therein, the computer readable code being configured such that, on execution by a suitable computer or processor, the computer or processor is caused to perform the method or methods described herein.

Thus, it will be appreciated that the disclosure also applies to computer programs 106. A computer program comprises instructions which, when executed on at least one processor of a security system 100, cause the security system 100 to carry out the method described herein.

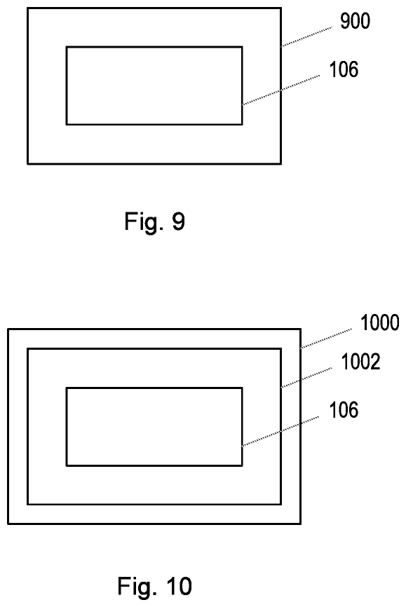

A computer program may be comprised on or in a carrier 900 as illustrated in FIG. 9, adapted to put embodiments into practice.

In other embodiments, as shown in FIG. 10 there is a computer program product 1000 comprising non-transitory computer readable media/computer readable storage medium 1002 having stored thereon a computer program 1006.

In more detail, the computer program 106 may be in the form of a source code, an object code, a code intermediate source and an object code such as in a partially compiled form, or in any other form suitable for use in the implementation of the method according to the embodiments described herein.

It will also be appreciated that such a program may have many different architectural designs. For example, a program code implementing the functionality of the method or system may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other.

The carrier of a computer program may be any entity or device capable of carrying the program. For example, the carrier may be or include a computer readable storage medium, such as a ROM, for example, a CD ROM or a semiconductor ROM, or a magnetic recording medium, for example, a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1.-20. (canceled)

21. A method performed by a security system for use in monitoring a computing system with respect to occurrence of a recovery scenario from which the computing system would require recovery, the method comprising:
determining a risk that the computing system will undergo the recovery scenario; and
the method characterized in that:
responsive to the determined risk, performing one or more pre-emptive actions so as to manage the recovery scenario as it progresses, wherein the pre-emptive actions are performed as the recovery scenario is occurring and wherein the pre-emptive actions comprise:
a) encrypting or deleting data from the computing system; and/or
b) disabling one or more components in the computing system.

22. The method according to claim 21, wherein the pre-emptive actions comprise:
c) adding a security control to compensate for the recovery scenario:
d) creating an image of part of the computing system; and/or
e) storing artifacts of the computing system in a storage space that is separate from the computing system.

23. The method according to claim 21, wherein the pre-emptive actions are to: secure the computing system against occurrence of the recovery scenario; and/or enable the computing system to be recovered if the recovery scenario occurs.

24. The method according to claim 21, wherein the determining of a risk that the computing system will undergo the recovery scenario comprises:
predicting a likelihood that the computing system will undergo the recovery scenario from system recovery indicators; and
wherein the risk is determined as a function of the predicted likelihood and an estimation of impact if the recovery scenario were to occur.

25. The method according to claim 21, wherein the pre-emptive actions are selected from the options a) and b) according to a type of the recovery scenario, so as to mitigate against said type of recovery scenario.

26. The method according to claim 21, wherein the pre-emptive actions are selected from the options a) and b) dependent on the risk.

27. The method according to claim 22, wherein the pre-emptive actions are selected from the options c), d) and e) according to a type of the recovery scenario, so as to mitigate against said type of recovery scenario.

28. The method according to claim 22, wherein the pre-emptive actions are selected from the options c), d) and e) dependent on the risk.

29. The method according to claim 22, wherein the performing of one or more pre-emptive actions is performed responsive to the risk being above a first pre-determined threshold risk.

30. The method according to claim 29, wherein the pre-emptive actions comprise option c) when the risk is above the first pre-determined threshold risk.

31. The method according to claim 22, wherein the pre-emptive actions comprise option d) when the risk is above a second pre-determined threshold risk.

32. The method according to claim 31, wherein the pre-emptive actions comprise options a) or b) when the risk is above a third pre-determined threshold risk.

33. The method as in claim 32, wherein the performing of one or more preemptive actions is performed responsive to the risk being above a first pre-determined threshold risk, and the third pre-determined threshold risk represents a higher risk than the second pre-determined threshold risk; and/or
wherein the second pre-determined threshold risk represents a higher risk than the first pre-determined threshold risk.

34. The method according to claim 21, wherein the recovery scenario is caused by:
an external attack on the computing system;
a system failure of the computing system;
an adverse environmental condition affecting the computing system;
an uncontrolled system change in or related to the computing system; and/or
a human error which has affected the computing system.

35. The method according to claim 21, comprising repeating:
the determining a risk that the computing system will undergo the recovery scenario; and
responsive to the determined risk, performing one or more pre-emptive actions so as mitigate against occurrence of the recovery scenario;
in an iterative manner.

36. A security system for use in monitoring a computing system with respect to occurrence of a recovery scenario from which the computing system would require recovery, the security system comprising:
a memory comprising instruction data representing a set of instructions; and
a processor configured to communicate with the memory and to execute the set of instructions, wherein the set of instructions, when executed by the processor, cause the security system to:
determine a risk that the computing system will undergo the recovery scenario; and
characterized in that, the set of instructions, when executed by the processor, cause the security system to:
perform one or more pre-emptive actions so as to manage the recovery scenario as it progresses, wherein the pre-emptive actions are performed as the recovery scenario is occurring and wherein the pre-emptive actions comprise:
a) encrypting or deleting data from the computing system; and/or
b) disabling one or more components in the computing system.

37. The security system as in claim 36, wherein the pre-emptive actions comprise:
c) adding a security control to compensate for the recovery scenario;
d) creating an image of part of the computing system; and/or
e) storing artifacts of the computing system in a storage space that is separate from the computing system.

38. The security system as in claim 36, wherein the pre-emptive actions are to: secure the computing system against occurrence of the recovery scenario; and/or enable the computing system to be recovered if the recovery scenario occurs.

39. The security system as in claim 36, wherein the set of instructions cause the processor to determine a risk that the computing system will undergo the recovery scenario comprises the set of instructions cause the processor to:
predict a likelihood that the computing system will undergo the recovery scenario from system recovery indicators; and
wherein the risk is determined as a function of the predicted likelihood and an estimation of impact if the recovery scenario were to occur.

40. A computer program product comprising non transitory computer readable media having stored thereon a computer program which comprises instructions which, when executed on at least one processor of a security system, cause the security system to carry out a method according to claim 21.
